(19) United States
(12) Patent Application Publication
(10) Pub. No.: US 2017/0365973 A1
(43) Pub. Date: Dec. 21, 2017

(54) EXCHANGEABLE PUMP MODULE

(71) Applicant: Coherent, Inc., Santa Clara, CA (US)

(72) Inventor: Guenter HOLLEMAN, Goettingen (DE)

(21) Appl. No.: 15/186,294

(22) Filed: Jun. 17, 2016

(51) Int. Cl. H01S 3/0941; H01S 3/094

(52) U.S. Cl. CPC H01S 3/09415; H01S 3/094053; H01S 3/094038; H01S 3/094049

(57) ABSTRACT

A modular solid-state laser comprises a diode-laser pump module and a laser-enclosure. The diode-laser pump module produces a collimated beam of laser-radiation for pumping a gain-element within the laser-enclosure. The beam of pump laser-radiation is focused into the gain-element by optics located within the laser-enclosure. The diode-laser pump module can be replaced or exchanged without realigning optics located within the laser-enclosure.

### TECHNICAL FIELD OF THE INVENTION

The present invention relates in general to diode-laser pumping of solid-state lasers. The invention relates in particular to diode-laser pump modules that are exchangeable and replaceable in a modular solid-state laser.

### DISCUSSION OF BACKGROUND ART

Diode-lasers are efficient devices for converting electrical power into coherent optical power. For high-power applications, a plurality of diode-lasers are packaged together in a diode-laser module having common electrical connections and a common cooling base. Optical power from the individual diode-lasers is combined into a single output beam of laser-radiation that propagates from the diode-laser module. The output beam is typically multi-mode and highly divergent. Although the output beam can be used directly, a convenient way to deliver the output beam to an application is through an optical fiber attached to the diode-laser module. Such an optical fiber is commonly referred by practitioners of the art as a “transport fiber.” A transport fiber may be permanently attached as an integrated component of the diode-laser module, which is referred to as a “fiber pigtail.” Alternatively, a transport fiber may be detachable by way of connectors on an output port of the diode-laser module and on an input end of the transport fiber.

Diode-laser modules have become the prevailing devices for energizing or “pumping” solid-state gain-media in laser-oscillators and laser-amplifiers. Common solid-state gain-media include crystalline, glass, and semiconductor materials, which are fabricated into gain-elements in the form of rods, slabs, discs, and fibers. A beam of pump laser-radiation is focused into a gain-element.

Efficient pumping requires substantial spatial overlap between the focused beam of pump laser-radiation and a beam of laser-radiation to be amplified in the gain-element. By way of example, in an “end-pumped arrangement,” the focused pump beam is approximately cylindrical near the focus and coaxially aligned with the beam to be amplified. In a “disc geometry,” the pump beam is focused to a spot on the face of the disc that overlaps with the beam to be amplified, which is reflected from the disc. Performance of a laser-oscillator or laser-amplifier is therefore sensitive to alignment of the focused pump beam in the gain-element, which is in turn sensitive to precise alignment of the pump beam where it exits the transport fiber.

Diode-lasers have finite (albeit relatively long) operating lifetimes that depend on the operating environment. Diode-lasers are electrostatic discharge (ESD) sensitive devices that are susceptible to damage by unintended voltage spikes or mishandling. Water-cooled diode-laser modules are also vulnerable to failure due to corrosion and blockages. Because of this, many commercial diode-pumped solid-state laser products have replaceable diode-laser modules to provide for performance degradation or acute failure.

Products having a diode-laser module with a fiber pigtail can be designed to be disconnected at an output end of the transport fiber. However, the output end of the transport fiber has alignment tolerances close to limits achievable using conventional optical fiber connectors, as discussed above. Often the transport fiber has a “facet angle,” meaning the output face is deliberately tilted from a plane perpendicular to the geometrical axis of the transport fiber, which contributes an alignment variance. The output face is also susceptible to damage by contamination or mishandling, due to the high-intensity pump beam exiting the transport fiber.

Products having a transport fiber that can be disconnected from the diode-laser module can be designed to have the output end of the transport fiber permanently fixed within the solid-state laser. However, the output port of the diode-laser module and the connector end of the transport fiber are susceptible to damage by contamination or mishandling. If the transport fiber becomes damaged, the solid-state laser requires repair as the transport fiber is an integral component. Such repairs are inconvenient and expensive, especially when the solid-state laser is permanently aligned and sealed for reliability during manufacture.

There is need for an improved diode-pumped solid-state laser with a replaceable diode-laser module, having a design that minimizes vulnerability to contamination and mishandling when a diode-laser module is exchanged or replaced. Preferably, the diode-laser module can be reliably replaced without reducing performance due to misalignment of the pump-beam with the gain-element.

### SUMMARY OF THE INVENTION

In one aspect, a laser apparatus in accordance with the present invention comprises an optical fiber having an input end and an output end. A diode-laser delivers a beam of laser-radiation into the optical fiber through the input end. A connector-assembly body and a collimating lens are provided. The output end of the optical fiber is fixedly held in a closed end of the connector-assembly body. The beam of laser-radiation propagates out of the fixed output end of the optical fiber towards an open end of the connector-assembly body. The collimating lens is fixedly held within the connector-assembly body. The fixed collimating lens is arranged to intercept and collimate the beam of laser-radiation. A laser-enclosure is provided, which includes a focusing lens and a gain element. The collimated beam of laser-radiation propagates out through the open end of the connector-assembly body and into the laser-enclosure via an entrance-aperture therein. The focusing lens is arranged to intercept the collimated beam of laser-radiation and to focus the beam of laser-radiation into the gain-element. The focused beam of laser-radiation energizes the gain-element. The connector-assembly body is attached to the laser-enclosure and is detachable from the laser-enclosure. The fixed collimating lens is arranged such that the collimated beam of laser-radiation is collinear with a preferred alignment axis defined with respect to the connector-assembly body.

### BRIEF DESCRIPTION OF THE DRAWINGS

The accompanying drawings, which are incorporated in and constitute a part of the specification, schematically illustrate a preferred embodiment of the present invention, and together with the general description given above and the detailed description of the preferred embodiment given below, serve to explain principles of the present invention.

FIG. 1 is plan-view from above, partially in cross-section, schematically illustrating one preferred embodiment of modular laser apparatus in accordance with the present invention, comprising a diode-laser pump module connected to a laser-enclosure, the diode-laser pump module delivering an aligned beam of laser-radiation for energizing a gain-element.

FIG. 2 is a plan-view from above, partially in cross-section, schematically illustrating the preferred embodiment of laser apparatus in FIG. 1, with the diode-laser pump module not operating and disconnected from the laser-enclosure.

FIG. 3 is a plan-view from above, partially in cross-section, schematically illustrating one preferred embodiment of pump module alignment apparatus in accordance with the present invention, for aligning the diode-laser pump module in the apparatus of FIG. 1.

FIG. 4 is a graph schematically illustrating measured beam diameter as a function of displacement in the beam-propagation direction, for six different diode-laser pump modules after an alignment procedure using the pump module alignment apparatus of FIG. 3.

### DETAILED DESCRIPTION OF THE INVENTION

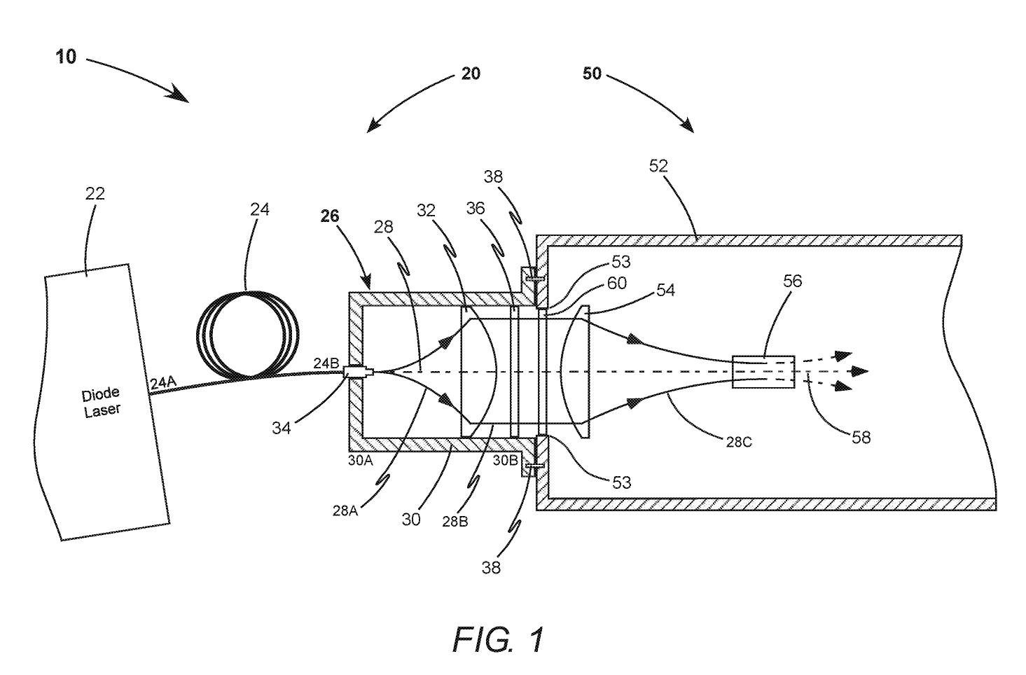

Turning now to the drawings, wherein like features are designated by like reference numerals, FIG. 1 schematically illustrates one preferred embodiment of modular laser apparatus 10 in accordance with the present invention. Modular laser apparatus 10 comprises a diode-laser pump module 20 that includes a diode-laser 22, an optical fiber 24, and a connector-assembly 26. Optical fiber 24 has an input end 24A attached to diode laser 22 and an output end 24B fixedly attached to connector-assembly 26. Diode laser 22 generates a beam of laser-radiation that is delivered through optical fiber 24 to connector-assembly 26. The beam of laser-radiation is designated generally by a principal axis 28 and by boundary rays when propagating in free space. 28A designates a diverging portion, 28B designates a collimated portion, and 28C designates a focused portion of the beam of laser-radiation.

Connector-assembly 26 includes a connector-assembly body 30 (hatched) and a collimating lens 32. Output end 24B of optical fiber 24 is secured mechanically in a closed end 30A of connector-assembly body 30 by a fiber-connector 34, thereby fixing permanently the alignment of beam of laser-radiation 28 with respect to connector-assembly body 30. Fiber-connector 34 incorporates termination of output end 24B of optical fiber 24, which may simply be polished flat and anti-reflection coated, or may include an endcap for high-power operation. Those skilled in the art of fiber-optic design would recognize that fiber-connector 34 may be fabricated or purchased having specifications appropriate for a specific application, without departing from the spirit and scope of the present invention. Beam of laser-radiation 28 is highly diverging as it emerges from output end 24B of optical fiber 24 and propagates towards an open end 30B of connector-assembly body 30.

Collimating lens 32 is arranged to intercept and collimate beam of laser-radiation 28 before diverging beam 28A emerges from open end 30B of connector-assembly body 30. Collimating lens 32 is secured mechanically within connector-assembly body 30, thereby fixing alignment of collimated beam 28B with respect to connector-assembly body 30. Connector-assembly 26 may also include an optional window 36 at the open end 30B of connector-assembly body 30 for protection against particle and chemical contamination.

Modular laser apparatus 10 further comprises a laser-enclosure 50 that includes a laser-enclosure body 52 (hatched), a focusing lens 54, and a gain-element 56. Laser-enclosure 50 supports and protects a plurality of other elements (not shown) that together make a laser-oscillator or laser-amplifier. These other elements are particular to the specific laser-oscillator or laser amplifier design and a detailed description thereof is not necessary for understanding principles of the present invention. An entrance aperture 53 in laser-enclosure 50 is defined by edges of laser-enclosure body 52.

Connector-assembly body 30 is attached to laser-enclosure body 52 such that open end 30B is adjacent to entrance aperture 53. Connector-assembly body 30 is precisely situated by location pins 38. Connector-assembly 26 is thereby mechanically referenced to laser-enclosure 50. Practitioners in the art of mechanical design would appreciate that the connector-assembly could be attached and situated on the laser-enclosure body by alternative means, without departing from the spirit and scope of the present invention.

Beam of laser-radiation 28 propagates from connector-assembly 26 into laser-enclosure 50. Focusing lens 54 is arranged to intercept collimated beam 28B and focus the beam of laser-radiation into gain-element 56. Focused beam 28C is substantially absorbed by gain-element 56, thereby energizing gain-element 56. Here “substantially absorbed” means any residual beam of laser-radiation 58 transmitted through gain-element 56 retains only a small fraction of the power in focused beam 28C incident on the gain-element. Laser-enclosure 50 may include an optional window 60 that transmits collimated beam 28B and protects elements inside the laser-enclosure from contamination.

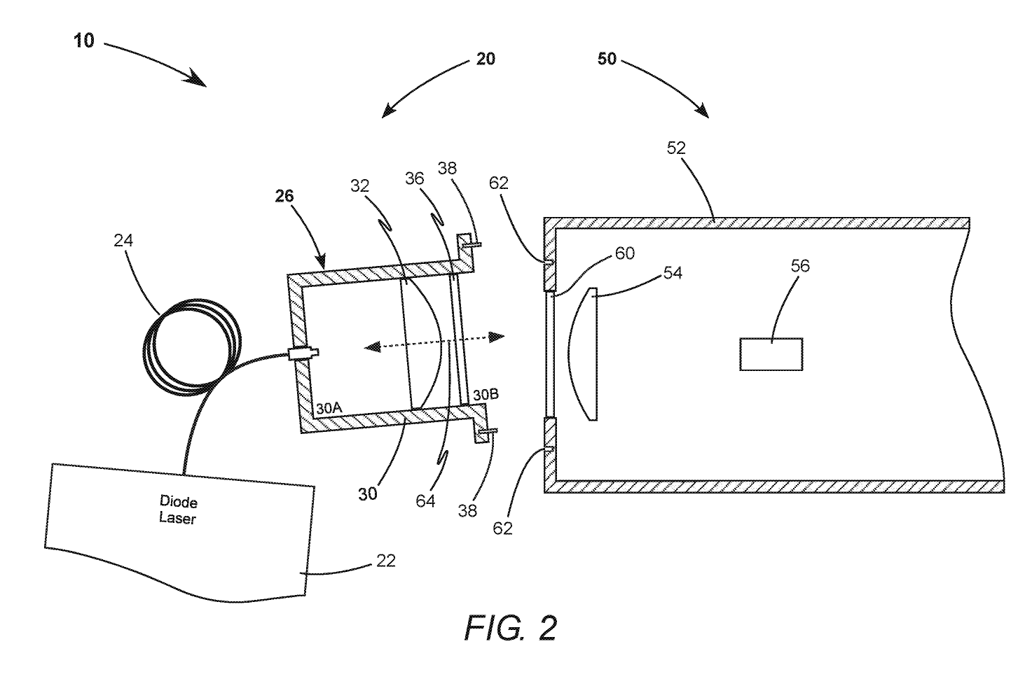

FIG. 2 schematically illustrates modular laser apparatus 10 with diode-laser pump module 20 not operating and disconnected from laser-enclosure 50. Comparing FIGS. 1 and 2, mechanical connection and disconnection occurs where beam of laser-radiation 28 is collimated, which has two main advantages.

First, collimated beam 28B is the most forgiving of lateral and angular misalignment. Double-arrowed dashed-line 64 represents a preferred alignment axis for collimated beam 28B emerging from connector-assembly 26. Principal axis 28 of collimated beam 28B may be translated and tilted with respect to preferred alignment axis 64, with minimal impact on location and shape of focused beam 28C in gain-element 56. Similarly, focused beam 28C depends weakly on waist-location and waist-size of collimated beam 28B.

Second, collimated beam 28B is largest and therefore least damaging to optical surfaces, especially any optical surfaces having mechanical defects or contamination. Diode-laser pump module 20 and laser-enclosure 50 are thereby less vulnerable to damage by mishandling or exposure to contaminants. In designs that include optional windows 36 and 60, optical damage can be further mitigated by making the windows from relatively hard materials and by making external surfaces of the windows accessible for cleaning.

Location pins 38 in connector-assembly body 30 and complementary location holes 62 in laser-enclosure body 52 are depicted in FIG. 2. Location pins situate the connector-assembly body with precise lateral location and orientation. Alternative designs allowing connector-assembly 26 to rotate about preferred alignment axis 64 would work in most applications because the present invention is insensitive to lateral and angular misalignment.

Gain-element 56 is depicted in FIGS. 1 and 2 in the form of an end-pumped rod. It is noteworthy that the present invention retains advantages of alignment insensitivity and invulnerability to contamination for other forms of the gain-element and other pumping arrangements.

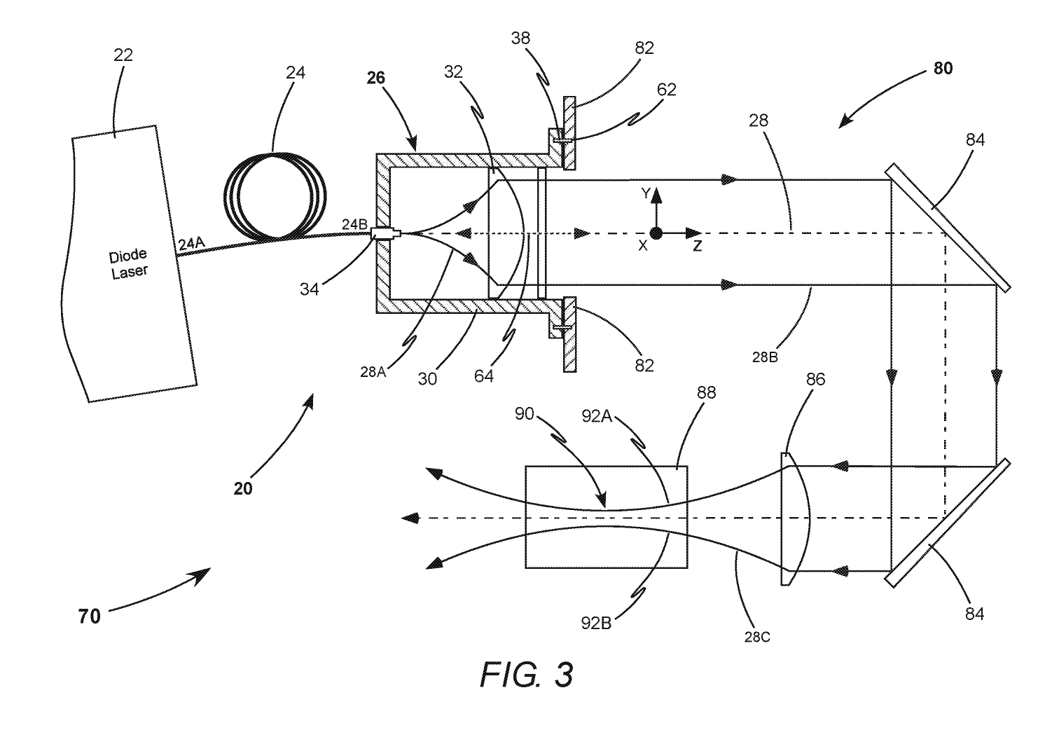

FIG. 3 schematically illustrates one preferred embodiment of pump module alignment apparatus 70 for aligning beam of laser-radiation 28 exiting connector-assembly 26 of diode-laser pump module 20. Pump module alignment apparatus 70 includes pump module alignment tooling 80 described in detail herein below. Connector-assembly 26 is attached to pump module alignment tooling 80 in manner similar to modular laser apparatus 10, with connector-assembly body 30 attached to a tooling mount 82 instead of laser-enclosure body 52. Location pins 38 fit into location holes 62 in tooling mount 82. The tooling mount is a permanently fixed mechanical reference that locates and orients connector-assembly 26.

Pump module alignment tooling 80 further includes wedged tooling mirrors 84 for attenuating beam of laser-radiation 28. Wedged tooling mirrors 84 direct the attenuated beam through a tooling focusing lens 86 and into beam-diagnostic tooling 88. Tooling focusing lens 86 may be identical to focusing lens 54 (shown in FIG. 1), thereby producing a focused beam identical in shape to focused beam 28C in modular laser apparatus 10. Alternatively, tooling focusing lens 86 may be selected for compatibility with beam-diagnostic tooling 88. It is straightforward to calculate differences between focused beams in modular laser apparatus 10 and pump module alignment apparatus 70 due to different specifications of focusing lenses. Focused beam 28C has a caustic and a focus location 90. The caustic is defined by boundary rays 92A and 92B of the focused beam. The caustic includes the diameter of the focused beam at focus location 90 and the shape of the focused beam about focus location 90.

The objective of an alignment procedure is consistent alignment of every diode-laser pump module 20, by aligning collimating lens 32 to create a focused beam having a target caustic in beam-diagnostic tooling 88, corresponding to a preferred optical and mechanical alignment. Therefore tooling mount 82, wedged tooling mirrors 84, tooling focusing lens 86, and beam-diagnostic tooling 88 are mechanically fixed with respect to each other. A simple way to fix these elements is to mount them all on a common tooling plate (not shown). A reference laser (not shown) optically and mechanically referenced to tooling mount 82 may be used to maintain consistent alignment of pump module alignment tooling 80 and to facilitate replacement of any elements of the pump module alignment tooling.

An exemplary alignment procedure aligns collimating lens 32 by translating it in x, y, and z-directions until caustic 92A and 92B of focused beam 28C matches the target caustic. The z-direction is the propagation direction of beam of laser-radiation 28, as indicated in the drawing. The three mutually-orthogonal translations are performed iteratively. Collimating lens 32 is then fixed permanently within connector-assembly body 30. Tooling for aligning and fixing collimating lens 32 is not depicted in FIG. 3. Means for aligning and fixing a lens are well known in the art. By way of example, aligning may be performed using commercial translation stages, such as those supplied by ThorLabs of Newton, N.J. Fixing may be accomplished using soldering technology, such as the methods taught in U.S. Pat. No. 5,930,600. Fixing may also be accomplished using an adhesive.

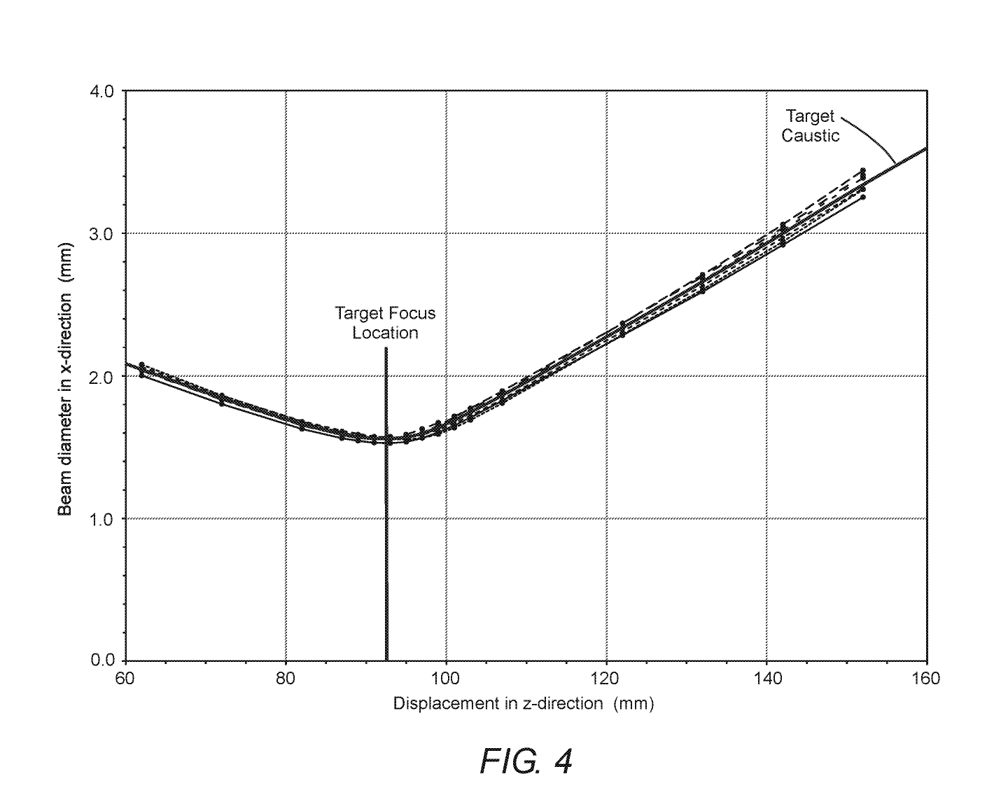

FIG. 4 is a graph depicting measured beam diameter in the x-direction, near focus location 90, as a function of displacement in the z-direction from tooling focusing lens 86. Here, the beam diameter was measured at 5% of the fitted peak intensity at the center of the beam. FIG. 4 includes measurements for six diode-laser pump modules 20 after each was aligned using the exemplary alignment procedure. Beams of laser-radiation produced by the six diode-laser pump modules were highly multi-mode, having a beam-quality (M²) of approximately 50. The measurements depicted in FIG. 4 were obtained using a 100 mm (millimeter) focal length lens (86 in FIG. 3) and a NanoModeScan laser-beam-profiler from Ophir Photonics of North Logan, Utah (88 in FIG. 3). FIG. 4 illustrates minimal residual variances in focus location and caustic after the alignment procedure, which are representative of variances in the focused beam when the diode-laser pump modules are installed in modular laser apparatus 10 (shown in FIG. 1).

Referring again to FIG. 1, after an alignment procedure, diode-laser pump module 20 generates collimated beam 28B that propagates from connector-assembly 26. Principal axis 28 of collimated beam 28B is collinear with preferred alignment axis 64 (shown in FIGS. 2 and 3), which is optically and mechanically referenced with respect to connector-assembly body 30 and laser-enclosure body 52. Focused beam 28C will have a beam waist at a preferred location within gain-element 56 and will have a preferred caustic in gain-element 56. When building a solid-state laser within laser-enclosure 50, the solid-state laser is aligned around a volume within gain-element 56 energized by focused beam 28C. There is no further adjustment of diode-laser pump module 20. The location of focusing lens 54 may be adjusted during the solid-state laser build, if necessary, without affecting the exchangeability of aligned diode-laser pump module 20.

For optical fibers 24 having a facet angle on output end 24B, diverging beam 28A is refracted from the geometrical axis of fiber 24, with variances in refracted angle and orientation. To compensate for these variances, another exemplary alignment procedure would include aligning and fixing fiber-connector 34 within connector-assembly body 30. Referring again to FIG. 3, focused beam 28C is aligned to a target focus location 90 and a target beam diameter at focus location 90 by translating fiber-connector 34 in the x, y, and z-directions. Principal axis 28 of collimated beam 28B is thereby made parallel to preferred optical axis 64. Focused beam 28C is then aligned to a target caustic 92A and 92B by translating fiber-connector 34 and collimating lens 32 together in the x and y-directions, thereby making principal axis 28 of collimated beam 28B collinear with preferred alignment axis 64. Fiber-connector 34 and collimating lens 32 are then fixed permanently within connector assembly body 30.

In some applications, it may be preferable to separate functions of connector-assembly body 30 between a plurality of elements. For example, a first element for mounting collimating lens 32, a second element for holding fiber-connector 34, and a third element for sealing connector-assembly 26. The first and second elements would be references for optical and mechanical alignment. The third element may be installed after aligning and fixing collimating lens 32 and fiber-connector 34.

For reliability and convenience, all the elements of diode-laser pump module 20 may be packaged into a common enclosure (not shown). Such an enclosure would have connectors for external electrical connection and ports for external water connection.

The present invention is described above in terms of a preferred embodiment and other embodiments. The invention is not limited, however, to the embodiments described and depicted herein. Rather, the invention is limited only by the claims appended hereto.

1. Laser apparatus comprising:
an optical fiber having an input end and an output end;
a diode-laser delivering a beam of laser-radiation into the optical fiber through the input end;
a connector-assembly body and a collimating lens, the output end of the optical fiber fixedly held in one end of the connector-assembly body, the beam of laser-radiation propagating out of the fixed output end of the optical fiber towards the opposed end of the connector-assembly body, the collimating lens fixedly held within the connector-assembly body, the fixed collimating lens arranged to intercept and collimate the beam of laser-radiation;
a laser-enclosure including a focusing lens and a gain-element, the collimated beam of laser-radiation propagating out through the opposed end of the connector-assembly body and into the laser-enclosure via an entrance-aperture therein, the focusing lens arranged to intercept the collimated beam of laser-radiation and to focus the beam of laser-radiation into the gain-element, the focused beam of laser-radiation energizing the gain-element; and
wherein the connector-assembly body is mechanically referenced and attached to the laser-enclosure and is detachable from the laser-enclosure, and the fixed collimating lens is arranged such that the collimated beam of laser-radiation is collinear with a preferred alignment axis defined with respect to the connector-assembly body.

2. The apparatus of claim 1, wherein mechanical attaching and detaching of the connector-assembly body and laser-enclosure occurs at a location within a collimated portion of the beam of laser-radiation.

3. The apparatus of claim 1, wherein the connector-assembly body is detachable from the laser-enclosure between the collimating lens and the focusing lens.

4. The apparatus of claim 1, wherein the connector-assembly body is mechanically referenced to the laser-enclosure by location pins on one of the connector-assembly body and laser enclosure, said pins engaging complementary location holes in the other of the connector assembly body or laser-enclosure.

5. The apparatus of claim 1, wherein a protective window is located at the opposed end of the connector-assembly body.

6. The apparatus of claim 1, wherein a protective window covers the entrance-aperture of the laser-enclosure.

7. The apparatus of claim 1, wherein the gain-element has the form of a rod and is end-pumped by the beam of laser-radiation.

8. The apparatus of claim 1, wherein the collimating lens is fixedly held within the connector-assembly body by soldering.

9. The apparatus of claim 4 wherein the connector-assembly body includes a planar radial flange extending in a direction perpendicular to the propagation direction of the beam of laser-radiation, said radial flange abutting a planar wall of the laser-enclosure.
